(19) United States
(12) Patent Application Publication
(10) Pub. No.: US 2021/0194271 A1
(43) Pub. Date: Jun. 24, 2021

(54) SUNCHARGE PORTABLE VERTICAL MOBILE COMMUNICATION DEVICE CHARGING APPARATUS

(71) Applicant: Shadecraft, Inc., Pasadena, CA (US)

(72) Inventor: Armen Gharabegian, Glendale, CA (US)

(21) Appl. No.: 17/112,938

(22) Filed: Dec. 4, 2020

Related U.S. Application Data
(60) Provisional application No. 62/943,806, filed on Dec. 5, 2019.

(51) Int. Cl. H02J 7/35; H02J 7/00; H02J 7/02; H02J 50/10; H02J 50/80

(52) U.S. Cl. CPC H02J 7/35; H02J 7/0013; H02J 7/0045; H02J 50/10; H02J 50/80; H02J 7/02

(57) ABSTRACT

A portable vertical mobile device charging apparatus includes one or more solar cells; one or more rechargeable power sources, the one or more solar cells to charge the one or more rechargeable power sources; wireless charging circuitry, the one or more rechargeable power sources to provide power to the wireless charging circuitry; one or more vertically disposed wireless charging coils, the wireless charging circuitry to provide power to one or more vertically disposed wireless charging coils; and one or more straps or strapping assemblies, the one or more straps or strapping assemblies to hold a surface of the mobile communication device against a surface of the one or more vertically disposed wireless charging coils.

### RELATED APPLICATIONS

This application claims priority to provisional application serial No. 62/943,806, filed Dec. 5, 2019, the disclosure of which is hereby incorporated by reference.

### BACKGROUND

There is a need for portable vertical mobile communication device charging apparatuses or devices that can be utilized in outdoor applications. Currently, charging devices utilize flat horizontal surfaces.

### BRIEF DESCRIPTION OF THE DRAWINGS

FIG. 1A illustrates a portable mobile communication device charging apparatus according to some embodiments;

FIG. 1B illustrates a front side (or a second side) of a portable mobile communication device charging apparatus according to some embodiments;

FIG. 1C illustrates a free standing portable vertical mobile communication device charging apparatus according to some embodiments;

FIG. 2 illustrates a block diagram of a portable vertical mobile communication device charging apparatus according to some embodiments;

FIG. 3A illustrates a closed diagram of a portable vertical mobile communication device charging apparatus according to some embodiments;

FIG. 3B illustrate an open diagram of a portable vertical mobile communication device charging apparatus according to some embodiments; and

FIG. 4 illustrates a small portable vertical charging apparatus according to some embodiments.

### DETAILED DESCRIPTION

The foregoing, and other features and advantages of the invention, will be apparent from the following, more particular description of the preferred embodiments of the invention, the accompanying drawings, and the claims.

In the following detailed description, numerous specific details are set forth to provide a thorough understanding of claimed subject matter. For purposes of explanation, specific numbers, systems and/or configurations are set forth, for example. However, it should be apparent to one skilled in the relevant art having benefit of this disclosure that claimed subject matter may be practiced without specific details. In other instances, well-known features may be omitted and/or simplified so as not to obscure claimed subject matter. While certain features have been illustrated and/or described herein, many modifications, substitutions, changes and/or equivalents may occur to those skilled in the art. It is, therefore, to be understood that appended claims are intended to cover any and all modifications and/or changes as fall within claimed subject matter.

References throughout this specification to one implementation, an implementation, one embodiment, embodiments, an embodiment and/or the like means that a particular feature, structure, and/or characteristic described in connection with a particular implementation and/or embodiment is included in at least one implementation and/or embodiment of claimed subject matter. Thus, appearances of such phrases, for example, in various places throughout this specification are not necessarily intended to refer to the same implementation or to any one particular implementation described. Furthermore, it is to be understood that particular features, structures, and/or characteristics described are capable of being combined in various ways in one or more implementations and, therefore, are within intended claim scope, for example. In general, of course, these and other issues vary with context. Therefore, particular context of description and/or usage provides helpful guidance regarding inferences to be drawn.

Likewise, in this context, the terms “coupled”, “connected,” and/or similar terms are used generically. It should be understood that these terms are not intended as synonyms. Rather, “connected” is used generically to indicate that two or more components, for example, are in direct physical, including electrical, contact; while, “coupled” is used generically to mean that two or more components are potentially in direct physical, including electrical, contact; however, “coupled” is also used generically to also mean that two or more components are not necessarily in direct contact, but nonetheless are able to co-operate and/or interact. The term “coupled” is also understood generically to mean indirectly connected, for example, in an appropriate context.

The terms, “and”, “or”, “and/or” and/or similar terms, as used herein, include a variety of meanings that also are expected to depend at least in part upon the particular context in which such terms are used. Typically, “or” if used to associate a list, such as A, B or C, is intended to mean A, B, and C, here used in the inclusive sense, as well as A, B or C, here used in the exclusive sense. In addition, the term “one or more” and/or similar terms is used to describe any feature, structure, and/or characteristic in the singular and/or is also used to describe a plurality and/or some other combination of features, structures and/or characteristics.

Likewise, the term “based on,” “based, at least in part on,” and/or similar terms (e.g., based at least in part on) are understood as not necessarily intending to convey an exclusive set of factors, but to allow for existence of additional factors not necessarily expressly described. Of course, for all of the foregoing, particular context of description and/or usage provides helpful guidance regarding inferences to be drawn. It should be noted that the following description merely provides one or more illustrative examples and claimed subject matter is not limited to these one or more illustrative examples; however, again, particular context of description and/or usage provides helpful guidance regarding inferences to be drawn.

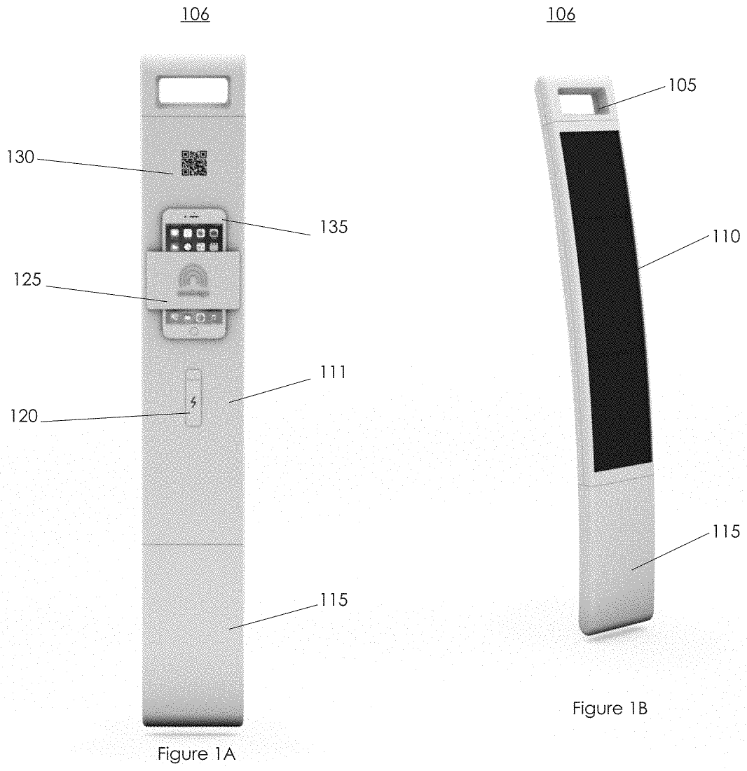

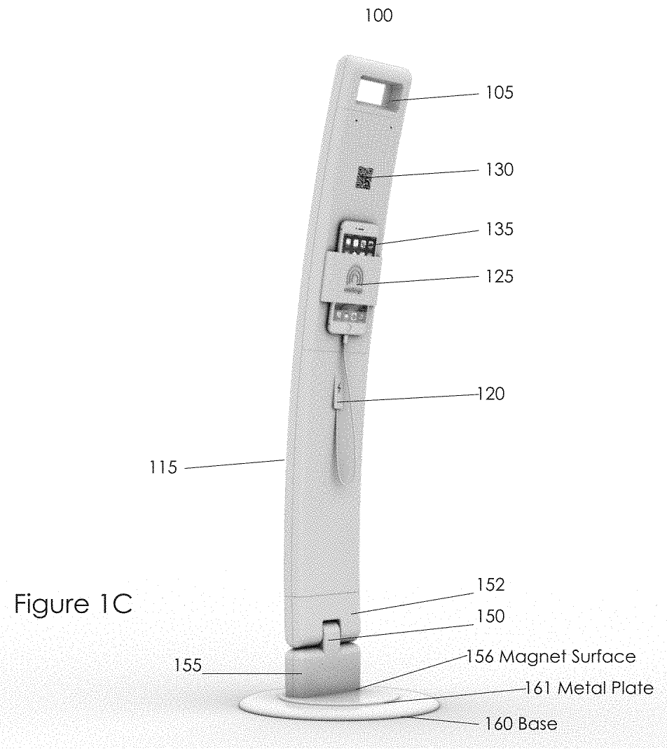

FIG. 1A illustrates a portable mobile communication device charging apparatus according to some embodiments. In some embodiments, an important aspect of the claimed subject matter is the ability to charge mobile communication devices that are placed in a vertical orientation against an inductive charging surface. In some cases, the vertical charging occurs in an outdoor area. The portable vertical mobile communications device charging apparatus may be placed into and/or inserted into a loose ground surface, such as sand, for charging at a beach or other area that includes a loose ground surface. In this way, the sun is not directly shining on the display of the mobile communication device which may cause overheating. FIG. 1A illustrates a back side (or a first side) of the portable vertical mobile communication device charging apparatus according to some embodiments. In some embodiments, the portable vertical mobile communications device charging apparatus 100 may comprise a scannable code 130 (e.g., a QR code) printed on a surface of the charging apparatus upper body 111, an inductive charging strap holder 125, a charging port 120, a charging apparatus lower body 115. In some embodiments, the charging port 120 may comprise a universal serial bus (USB) charging port and/or a barrel charger for charging a rechargeable power source within the portable vertical mobile communication device charging apparatus 100. In some embodiments, the inductive charging strap holder 125 may hold a mobile communication device 135 against an inductive charging assembly or coil (not shown in FIG. 1A). In some embodiments, in order to start using the portable mobile communication device charging apparatus 100, the user or operator may utilize a camera or scanner on the mobile communication device 135 to scan and/or capture the scannable code 130 and communicate with a web site to begin tracking the user's usage of the portable vertical mobile communication device charging apparatus 100. In some embodiments, the strap or strapping assembly 125 may be made of a plastic material, a composite material, a leather material and/or a heavy cloth or fabric material (or combination thereof).

FIG. 1B illustrates a front side (or a second side) of a portable mobile communication device charging apparatus according to some embodiments. In some embodiments, the mobile communication device charging apparatus 100 includes a handle 105, a charging apparatus upper body 111, one or more solar cells or arrays 110 and a charging apparatus lower body 115. In some embodiments, the handle 105 may allow a user or operator to grab and/or carry the charging apparatus 100. In some embodiments, the one or more solar cells or arrays 110 may be positioned and/or integrated within a back surface (or second side or surface) of the charging apparatus upper body 111. In some embodiments, the one or more solar cells or arrays 110 may convert sunlight or sun power into electrical energy, which in turn provides power to one or more rechargeable batteries in the portable vertical mobile communication device charging apparatus 100.

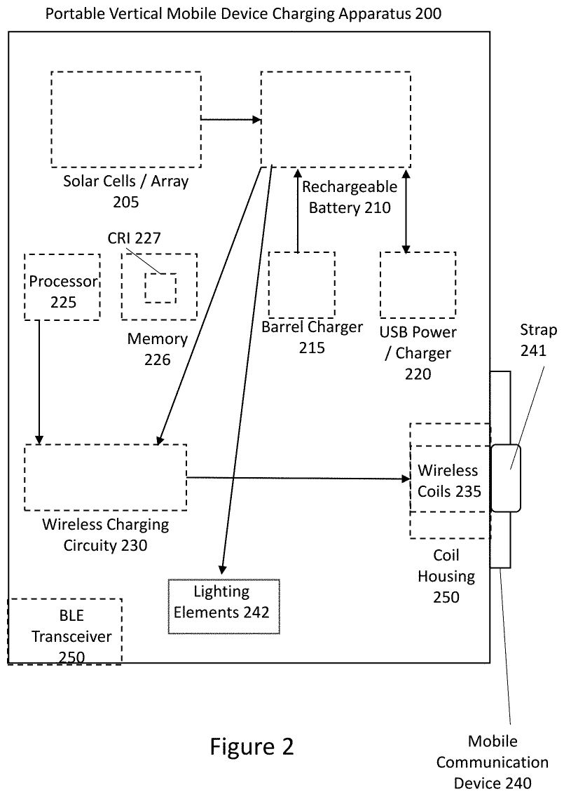

FIG. 2 illustrates a block diagram of a portable vertical mobile communication device charging apparatus according to some embodiments. In some embodiments, the portable vertical mobile communication device charging apparatus 200 may comprise one or more solar cells or arrays 205, one or more rechargeable batteries 210, one or more barrel chargers 215, one or more USB chargers and/or charging devices 220, one or more processors 225, one or more memory devices 226, computer-readable instructions 227 stored in the one or more memory devices 226 and/or executable by one or more processors 225, a wireless charging chipset or wireless charging circuitry 230, one or more lighting elements 242 and/or one or more wireless charging coils 235. In some embodiments, the portable vertical mobile communication charging apparatus 200 may comprise one or more wireless communication transceivers 250. In some embodiments, the one or more wireless communication transceivers 250 may be a Bluetooth Low Energy transceiver 250.

In some embodiments, a mobile communication device 240 may be held again the body of the portable vertical mobile device charging apparatus 200 may a strap 241 or strapping assembly. In some embodiments, the strap or strapping assembly 241 may be connected to the body of the portable vertical mobile communications device charging apparatus 200. In some embodiments, the strap or strapping assembly 241 may be connected to the body of the charging apparatus 200 via connectors, fasteners, screws or adhesives. In some embodiments, the strap or strapping apparatus 241 may be made of a fabric, a plastic material, an elastic material, a rubber or neoprene material, a material that is both flexible and can hold up to ten or twenty pounds or less (e.g., the weight of the mobile communication device) against the body of the portable vertical mobile communication device charging apparatus 200. The strap or strapping assembly 241 may hold the mobile communication device 240 against the charging apparatus body 200 in a vertical orientation. This is different than other wireless charging systems where the mobile communication device is placed in a horizontal orientation when next to wireless charging coils 235. This is a unique and novel aspect of the present invention. This is an improvement because it allows users to charge devices in more locations where less space is needed. In other words, if the portable vertical charging apparatus holds the mobile communication device in a vertical orientation, a smaller footprint (in terms of width) is needed for the charging apparatus. In addition, a flat horizontal surface does not have to be located in order to install the wireless charging coils.

In some embodiments, the wireless coils 235 may be installed in a coil housing 236. In some embodiments, the coil housing 236 may have a vertical orientation. In some embodiments, the coil housing may be made of a plastic material, a composite material, a material made utilizing additive manufacturing techniques, a lightweight metal material, a wood material or a combination of any the previous elements mentioned above. In some embodiments, the portable vertical mobile device charging apparatus 200 may comprise a wireless communication transceiver 250, which in some cases may be a Bluetooth Low Energy (BLE) transceiver to allow the charging apparatus to communicate with other electronic devices (e.g., mobile communication devices, other computing devices, and/or other charging apparatus devices).

In some embodiments, the strap or strapping assembly 241 may comprise a wire or cable and/or the charging coils. In some embodiments, the wire or cable may connect or couple the wireless charging chipset 230 to the charging coils that are located within the strap or strapping assembly 241. This moves the charging coils into the strap or strapping assembly. In some embodiments, the computer-readable instructions 227 executable by the one or more processors 225 may control operations of the portable vertical mobile communication device charging apparatus (and/or components of the portable vertical mobile communication device charging apparatus 200. In some embodiments, these components may include the one or more lighting elements and/or the wireless communication chipset or circuitry 230. In some embodiments, the computer-readable instructions 227 executable by the one or more processors 225 may communication with a mobile communication device or other computing device in order to activate and/or turn on the portable vertical mobile communication device charging apparatus and/or to capture parameters and/or measurements and/or communicate parameters and/or measurements to other computing devices or electronic apparatuses.

FIG. 1C illustrates a free standing portable vertical mobile communication device charging apparatus according to some embodiments. In some embodiments, the components in FIG. 1C for a top portion of the free standing portable vertical mobile communication device charging apparatus are the same as the components in the portable vertical mobile communication device charging apparatus 100 illustrated in FIG. 1B. In addition, in order to make the vertical mobile communication device charging apparatus free standing on a ground surface, a base may be added to the charging apparatus. In some embodiments, the base may comprise a base plate 160, a metal plate 161 and a hinging assembly. In some embodiments, the hinging assembly may comprise an upper portion 152, a hinge 150 and/or a lower portion 155. In some embodiments, a surface of the lower portion 155 may be a magnetic surface 156. In some embodiments, the hinge 150 may allow the upper portion 152 to rotate with respect to the lower portion 155 and adjust the charging apparatus to face the sun so that the solar panels or cells 110 (FIG. 1B) may capture more sunlight. In some embodiments, the bottom surface of the lower portion 155 may be a magnetic surface 156 which may be attached to the metal plate 161 of the base. In some embodiments, this allows a user or operator to grab the charging apparatus and have the rest of the charging apparatus 100 move or rotate. This is because the metal plate 161 may be positioned in the base 160 and may be able to rotate 360 degrees. In other words, the metal plate 161 is free moving with respect to the base plate. In some embodiments, the metal plate and the base plate 160 may be circular or oval in shape.

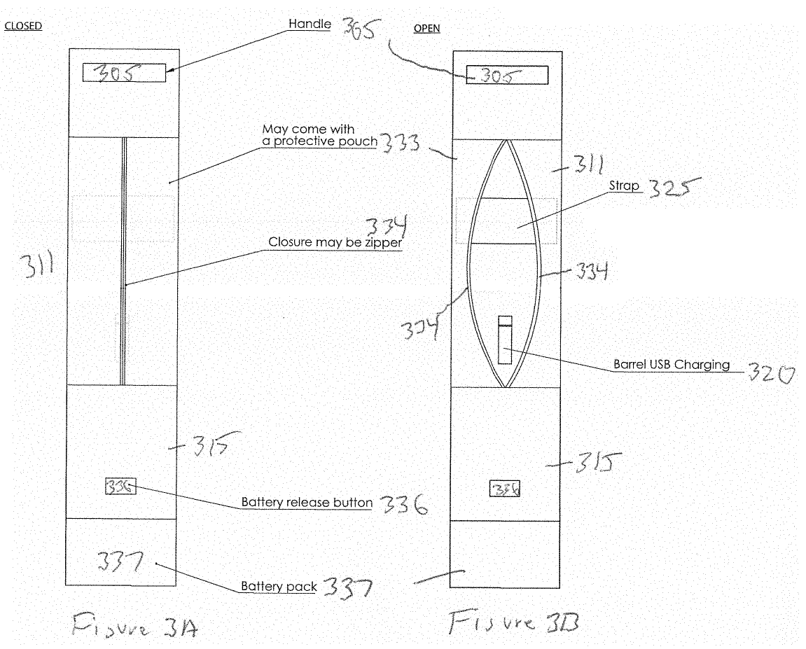

FIG. 3A illustrates a closed diagram of a portable vertical mobile communication device charging apparatus according to some embodiments. FIG. 3B illustrate an open diagram of a portable vertical mobile communication device charging apparatus according to some embodiments. In some embodiments, the portable vertical mobile communication device charging apparatus 300 may comprise a handle 305, an upper section 311, a lower section 315 and a battery pack 337. In some embodiments, the upper section 311 may include a protection pouch 333 and/or a closure device or assembly 334 (which may be a zipper). In some embodiments, in order to protect the strap assembly or strap 325 (and/or the wireless charging coils), the charging apparatus may comprise the protective pouch 333. In some embodiments, the protection pouch 333 may be made of a fabric material, a rubber material, a plastic material and/or a leather material. In some embodiments, the closure device (e.g., zipper) 334 may close an opening in the protective pouch 333 to provide this protection. In FIG. 3B, the closure device 334 may be opened (e.g., zipper unzipped) which creates an opening in the protective pouch 333 to allow a user or operator to use the charging apparatus 300 (e.g., have access to the strap or strapping assembly 325 and/or the barrel or USB charging port 320). In some embodiments, the charging apparatus 300 may further comprise a battery pack 337 and/or a battery release button 336. In some embodiments, the battery pack 337 may be released from the portable vertical charging apparatus 300 by utilizing or depressing the battery release button 336. Thus, in some embodiments, the battery pack 337 may be detachable.

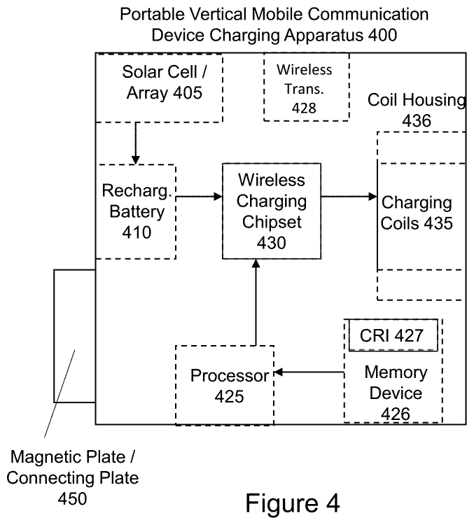

FIG. 4 illustrates a small portable vertical charging apparatus according to some embodiments. In some embodiments, the small portable vertical charging apparatus 400 may comprise one or more solar cells or arrays 405, one or more rechargeable battery or batteries 410, a wireless charging chipset or wireless charging circuitry 430, one or more charging coils 435, one or more processors 425, one or more memory devices 426, and/or computer-readable instructions 427 stored in the one or more memory devices 426 and/or executable by the one or more processors 425. In some embodiments, the small portable vertical charging apparatus 400 may also comprise one or more wireless communication transceivers 428 to communicate with other computing devices, wireless communication devices and/or charging apparatus devices. In some embodiments, the small portable vertical charging apparatus comprises a magnetic plate or connecting plate 450. In some embodiments, the magnetic plate or connecting plate 450 may allow the small portable vertical charging apparatus to be attached to a metallic vertical surface such as a refrigerator, or to a surface metal in public places like transportation centers (e.g., train stations, airports, etc.). In some embodiments, the connecting plate 450 may be an adhesive sticker that can be attached to a wall or other vertical surface such as an outdoor pole or an outdoor furniture's vertical surface. In some embodiments, the connecting plate or magnetic plate 450 may be attached to other vertical surfaces in outdoor environments. In some embodiments, this is unique and novel in that there are not other known vertical portable charging apparatus that can wirelessly charge mobile communication devices in outdoor environments.

In addition, the small vertical mobile communication device charging apparatus 400 may be between 6 inches to 2 feet in length, height and/or width. In some embodiments, the small vertical mobile communication device charging apparatus 400 may have a depth of between 3 inches to 18 inches. In some embodiments, the solar cells or arrays 405 may be placed on any of the surfaces of the small portable vertical charging apparatus 400 in order to capture light or sunlight and convert the light or sunlight into electrical power. In some embodiments, the power may be transferred to a charging apparatus or device which may charge the rechargeable power sources 410 (e.g., rechargeable batteries). In some embodiments, the rechargeable batteries 410 may generate voltage and/or current for other components in the small portable vertical charging apparatus 400 and this may include, but is not limited to the wireless charging chipset 430 and/or the one or more processors 425. In some embodiments, the wireless charging chipset 430 may provide current and/or voltage to the one or more charging coils 435. In some embodiments, the one or more charging coils 435 may generate a magnetic field which induces current into wireless coils in a mobile communication device and thus charges the mobile communication device (e.g., the rechargeable battery in the mobile communication device). In some embodiments, the one or more charging coils 435 may be installed in a coil housing 436 in the small portable vertical portable vertical charging apparatus 400 in order to provide stability to the one or more charging coils 435. In some embodiments, computer-readable instructions 427 executable by the one or more processors 425 may communicate commands, instructions and/or messages to the wireless charging chipset in order to initiate charging and/or activation of the one or more charging coils 435. In some embodiments, the one or more wireless communication transceivers 428 may receive commends, messages and/or instructions from external devices (e.g., computing devices, mobile communication devices, and/or other charging devices or apparatuses) to activate components in the small portable vertical charging apparatus 400 (including but not limited to the wireless charging chipset or circuitry 430) in order to power on or activate charging coils. In some embodiments, the small vertical portable mobile communication device charging apparatus can provide power parameters and/or power statistics to external computing devices via the one or more wireless communication transceivers 428. In some embodiments, the wireless charging chipsets or circuitry 430 may be ST Electronics STWBC-MC15, PowerbyProxi chipsets, Integrated Device Technology P9242 and P9247 wireless charging chipsets, and/or Dialog Semiconductor DA4100 chipsets. There are also many other wireless charging chipsets or circuitry.

In some embodiments, the small vertical portable mobile communication device charging apparatus 400 can capture sunlight in one location in order to charge up the one or more solar cells or arrays 405 (and in turn the one or more rechargeable batteries) 410 and then move the small vertical portable mobile communication device charging apparatus 400 to another location, adhere it or attach it to a vertical surface, where the charging apparatus 400 can then provide power to the mobile communication device.

In some embodiments, a portable vertical mobile device charging apparatus includes one or more solar cells; one or more rechargeable power sources, the one or more solar cells to charge the one or more rechargeable power sources; wireless charging circuitry, the one or more rechargeable power sources to provide power to the wireless charging circuitry; one or more vertically disposed wireless charging coils, the wireless charging circuitry to provide power to one or more vertically disposed wireless charging coils; and one or more straps or strapping assemblies, the one or more straps or strapping assemblies to hold a surface of the mobile communication device against a surface of the one or more vertically disposed wireless charging coils. The portable vertical mobile device charging apparatus further includes one or more processors, one or more memory devices and computer-readable instructions stored in the one or more memory devices, accessed from the one or more memory devices and executable by the one or more processors to cause components of the apparatus to perform certain operations. The portable vertical mobile device charging apparatus further includes a wireless communication transceiver, the wireless communication transceiver to receive commands to operate components or assemblies of the vertical mobile device charging apparatus. The portable vertical mobile device charging apparatus further includes one or more lighting elements, the one or more lighting elements to receive power from the one or more rechargeable power sources. The portable vertical mobile device charging apparatus further includes a barrel charger interface, the barrel charger interface to supply external power to the rechargeable power source. The portable vertical mobile device charging apparatus includes a Universal Serial Bus (USB) charging port, the USB charging port to receive or supply power to the rechargeable power source.

Different embodiments and/or implementations of the systems and techniques described here can be realized in digital electronic circuitry, integrated circuitry, specially designed ASICs (application specific integrated circuits), computer hardware, firmware, software, and/or combinations thereof. These different embodiments and/or implementations may include implementations or embodiments in one or more computer programs (e.g., computer-readable instructions) that are executable and/or interpretable on a programmable device, including one or more programmable processors, which may be special or general purpose, coupled to receive data and instructions from, and to transmit data and instructions to, one or more storage systems, one or more input devices, and one or more output devices.

In some embodiments, these computer programs (also known as programs, software, software applications or code) may include computer-readable instructions for one or more programmable processors, and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to the one or more programmable processors, including a machine-readable medium that receives machine instructions as a machine-readable signal.

To provide for interaction with a user, the systems and techniques described here can be implemented on a computing device having a display device (e.g., a CRT (cathode ray tube) or LCD (liquid crystal display) monitor) (or other display devices) for displaying information to the user and a keyboard, a touchscreen, and a pointing device (e.g., a mouse or a trackball), or one or more microphones and/or audio processing circuitry (e.g., codecs) by which the user can provide input to the computing device. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

In some embodiments, the systems and techniques described here can be implemented in a computing system that includes a back end component (e.g., as a data server or a database server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

In some embodiments, the computing system can include client devices and/or server devices. In some embodiments, a client device and/or server device are generally remote from each other (and/or not in the same location) and typically may interact through a communication network (e.g., a wired communication network or a wireless communication network). In some embodiments, the relationship of the client device and server device arises by virtue of computer programs running on the respective computing device and having a client-server relationship to each other.

A number of embodiments have been described. Nevertheless, it will be understood that various modifications may be made without departing from the spirit and scope of the invention. For example, much of this document has been described with respect to a wristwatch form factor, but other forms of devices may be addressed.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

The above disclosure is sufficient to enable one of ordinary skill in the art to practice the invention, and provides the best mode of practicing the invention presently contemplated by the inventor. While there is provided herein a full and complete disclosure of the preferred configurations of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

1. A portable vertical mobile device charging apparatus, comprising:
one or more solar cells;
one or more rechargeable power sources, the one or more solar cells to charge the one or more rechargeable power sources;
a wireless charging chipset, the one or more rechargeable power sources to provide power to the wireless charging chipset;
one or more vertically disposed wireless charging coils, the wireless charging chipset to provide power to one or more vertically disposed wireless charging coils; and
one or more straps or strapping assemblies, the one or more straps or strapping assemblies to hold a surface of the mobile communication device against a surface of the one or more vertically disposed wireless charging coils.

2. The portable vertical mobile device charging apparatus of claim 1, further comprising one or more processors, one or more memory devices and computer-readable instructions stored in the one or more memory devices, accessed from the one or more memory devices and executable by the one or more processors.

3. The portable vertical mobile device charging apparatus of claim 2, further comprising a wireless communication transceiver, the wireless communication transceiver to receive commands to operate components or assemblies of the vertical mobile device charging apparatus.

4. The portable vertical mobile device charging apparatus of claim 1, further comprising one or more lighting elements, the one or more lighting elements to receive power from the one or more rechargeable power sources.

5. The portable vertical mobile device charging apparatus of claim 1, further comprising a barrel charger interface, the barrel charger interface to supply external power to the rechargeable power source.

6. The portable vertical mobile device charging apparatus of claim 1, further comprising a Universal Serial Bus (USB) charging port, the USB charging port to receive or supply power to the rechargeable power source.
